(19) United States
(12) Patent Application Publication
(10) Pub. No.: US 2008/0203031 A1
(43) Pub. Date: Aug. 28, 2008

(54) Foam Composite for Absorption of Hydrocarbon and Process for Making Same

(76) Inventor: Timothy Thomson, West Newbury, MA (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/588,364

(22) PCT Filed: Feb. 3, 2005
(86) PCT No.: PCT/US05/02971

§ 371 Date: Aug. 2, 2006

Related U.S. Application Data
(60) Provisional application No. 60/541,371, filed on Feb. 3, 2004.

(51) Int. Cl. C02F 1/58; B32B 3/26; B29C 44/00

(52) U.S. Cl. 210/680; 428/304.4; 264/45.1

(57) ABSTRACT

A foam composite adapted to remove sparingly soluble hydrocarbon contaminants from water is provided. The adapted foam composite comprises a scaffold of an open cell hydrophobic polyurethane foam having a plurality of pores with a plurality of surfaces which have a coating of hydrophobic polyurethane disposed thereupon. The foam composite may be made by preparing a hydrophobic polyurethane prepolymer comprising the reaction product of a C8-C12 monohydric alcohol with a polyisocyanate, contacting an open cell hydrophobic polyurethane foam having a plurality of pores having a plurality of surfaces with the hydrophobic polyurethanes prepolymer and a polyol, and curing the prepolymer to form a coating of hydrophobic polyurethane on the surfaces of the pores of the hydrophobic polyurethane foam.

Straw or cotton or other mixed cellulosic materials are often used to absorb industrial oil spills. Cellulosic materials have a dusty character which is objectionable. These conventional oil-absorbing materials are therefore not ideal.

Granulated polystyrene foam has been used to absorb oil and hydrocarbons. The oil affinity of the surface of polystyrene is due to its hydrocarbon content. However, polystyrene materials must be “blown” or produced under carefully controlled factory conditions. Methylchloride is used as a blowing agent and high temperatures are required for carrying out the reactions involved. For these reasons, granulated polystyrene is too costly for most applications.

Faudree, U.S. Pat. No. 4,230,566, teaches the production of an alcohol-grafted polyurethane for the express purpose of absorbing water-borne oil spills. The drawback of this approach is that the polyurethane must be ground into a powder to increase its effective surface area. The powder is difficult to recover from the spill site.

As the transportation of petroleum products by sea has greatly expanded, significant oil spills have been encountered. When these spills migrate toward land, it has been necessary for governmental agencies and affected industries to carry out clean-up procedures. All currently envisioned procedures are of questionable effectiveness. Usually, elongate floating containers fashioned of inexpensive oil absorbents within a perforate retainer or casing are formed as absorbent booms in a line and floated against the oil slick to gradually confine and collect it. The absorbent materials used within these devices are essentially the same as described above in connection with industrial oil spills. These, in addition to having the noted relatively low oil pick-up ratio, tend to absorb water and sink after a limited period of use. The costs encountered in transporting the very light absorbing materials to the site of an oil collecting activity are prohibitive in view of the low density/high volume of the materials involved.

In U.S. Pat. No. 6,617,014 and related U.S. Patent Publication No. US-2002-0018884-A1 and its counterpart PCT Publication WO/01/74582 A1. Thomson teaches that an increase in surface area of polyurethane can be achieved by casting a hydrophilic polyurethane on the inside surfaces of the pores of a substantially open cell hydrophobic polyurethane foam. In his work, a hydrophilic polyurethane was cast on a reticulated hydrophobic polyurethane. The result is a high surface area, flow-through composite.

### SUMMARY OF THE INVENTION

The present invention is addressed to a new, low density, polymeric medium for absorbing hydrocarbons insoluble in water with significantly enhanced efficiency. The term absorption is used throughout this specification to describe both the phenomenon in which the hydrocarbon actually is absorbed within a volume of medium or is only adsorbed on the surfaces of the medium. Hence the term is a shorthand for both phenomenons.

The medium readily absorbs contaminant hydrocarbons in amounts ranging from 20 to 40 per unit weight of medium. The new material is producable utilizing the methods and systems of the invention. It can be used in a broad range of ambient temperatures and at costs competitive with the least expensive materials of lower efficiency heretofore available in the market.

A low-density cellular polyurethane polymer is provided having excellent water-insoluble hydrocarbon absorption characteristics. It is produced by first reacting a polyisocyanate with a long-chain monohydric alcohol or mixture of long-chain monohydric alcohols of about 8 to 12 carbon atoms to form a prepolymer. The prepolymer is then reacted with a polyol. Before any substantial reaction of this mixture takes place, it is applied to a substantially open-cell polyurethane foam so as to coat the surfaces of the pores of the open cell structure.

The material provided has a high capacity for adsorbing water-insoluble hydrocarbons such as oil and grease. Further, the material is characterized by a low absorption of water, thus improving its utilization as a material for treating water-borne oil spills.

The advantage of the medium resides in the high surface area and flow-through characteristics of the open-celled foam that serves as the scaffold on which the oil absorbing prepolymer/polyol reaction mixture is deposited.

### BRIEF DESCRIPTION OF THE DRAWINGS

FIG. 1 is a representation of the medium of the instant invention; and

FIG. 2 is a block flow diagram of the process of the invention.

### DETAILED DESCRIPTION OF THE INVENTION

Polyurethane foams having a broad range of physical characteristics have been produced by industry. The procedures generally utilized for preparing isocyanate terminated prepolymers and reacting these polymers to produce a rigid cellular foam have been described extensively. See for example, Saunders and Frisch, “Polyurethanes: Chemistry and Technology, II Technology” pp. 193-239, Interscience Publishers, New York 1964.

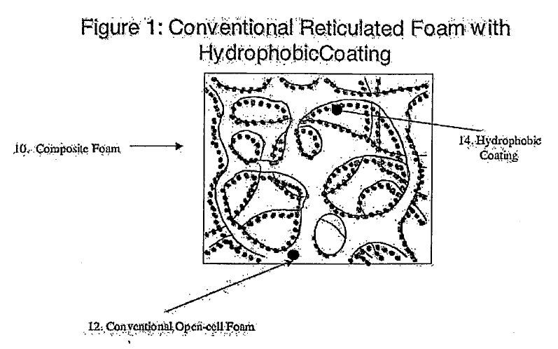

Referring to FIG. 1, the instant invention is a composite 10 composed of an open-celled polyurethane scaffold 12 on which a polyurethane coating 14 containing long-chain alcohols have been applied.

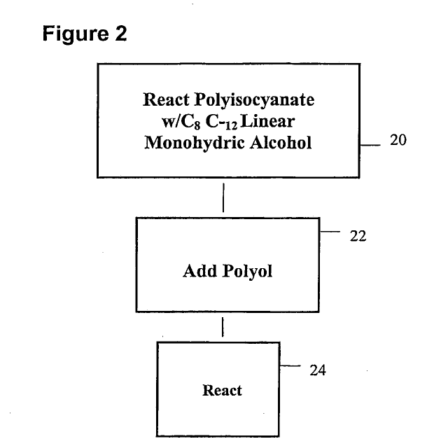

With reference to FIG. 2, the procedures for carrying out the process of the invention are outlined. Block 20 identifies a prereaction step wherein polyisocyanate is reacted with a linear, C₈-C₁₂ alcohol to provide the hydrocarbon affinity of the end product. Block 22 shows the subsequent addition of polyol. Block 24 is the reaction step between the prepolymer, i.e., the reaction product of polyisocyanate and long chain monohydric alcohol, with the polyol.

Greater surface affinity for oils or similar contaminant hydrocarbons can be achieved by increasing the average number of such carbon atoms, per molecule. However, as that number is increased, longer reaction times are encountered which tend to lessen the practicality of the process as achieved with the C₈-C₁₂ alcohols.

The amount of alcohol employed is about 10% to 25% of the stoichiometric amount that would be required for complete reaction with the polyisocyanate. The amount of alcohol employed with respect to the weight of polyisocyanate is important for achieving high absorbancies. Using C₁₀-C₁₂ alcohols mixes, for example it is preferably to use between 5 and 15% by weight of polyisocyanate. This achieves high absorbancies. The highest absorbancies are obtained with C₁₀-C₁₂ mixed alcohols at about 11% by weight polyisocyanate. Table 1 shows absorbancy data for a range of such alcohol content. The Absorbancy Ratio is defined as the weight in pounds of SAE 30 motor oil absorbed by 1 pound of the test material.

| % Available | Absorbency Ratio |
|---|---|
| NCO Reacted | (weight basis) |
| 0.10% | 28.7:1 |
| 5.30% | 29.8:1 |
| 11.10% | 34.4:1 |
| 12.90% | 25.5:1 |

Once the polyol is mixed with the reaction product of long chain alcohol and isocyanate, the process operator has a limited time to dispense the mixture onto an open-cell foam because the mixture should be applied onto the web of open cell foam before any significant reaction commences. The reaction mixture is therefore immediately forced into the open-celled foam by means of pinch rollers or scrapers or similar devices to ensure that the mixture is evenly distributed throughout the open-celled structure. A curing period follows.

The linear monohydric alcohol serves to increase surface affinity for hydrocarbons and, in view of its linear nature, serves to promote the flexibility of the polyurethane product due to its built-in plasticizing properties.

Polyisocyanates employed in the preparation of the prepolymer are readily commercially available and comprises an aliphatic, cycloaliphatic, or aromatic polyisocyanate having preferably from two to five isocyanate groups. If desired, mixtures of polyisocyanates can be employed. Suitable polyisocyanates include aliphatic polyisocyanates such as hexamethylene diisocyanate, alicyclic polyisocyanates such as 4,4′ dicyclohexylmethane diisocyanate, and aromatic polyisocyanates such as 2,4- and 2,6-tolylene diisocyanate, diphenylmethane diisocyanate, and the dimethyl derivatives thereof. Further examples of suitable polyisocyanates are 1,5-naphthalene diisocyanate, triphenylmethane triisocyanate, xylyene diisocyanate, and the methyl derivatives thereof, polymethylene polyphenyl isocyanates, chlorophenylene-2,4-diisocyanate, and the like.

The preferred polyisocyanates are aromatic polyisocyanates and particularly diphenylmethane diisocyanate, triphenylmethane triisocyanate, polymethylene polyphenylisocyanate and complex commercially-available compositions containing polymeric isocyanates sold under such trademarks as “PAPI”, “Mondur MR” and “NCO-120” and mixtures thereof.

Typical polyols employed in the methods of the invention include ethylene glycol, propylene glycol, butylene glycol, glycerol, trimethylolpropane, trimethylolethane, 1,2,6-hexanetriol, pentaerythritol, diethylene glycol, dipropyleneglycol, and the like. Typical dicarboxylic acids include adipic acid, succinic acid, azaleic acid, phthalic acid, isophthalic acid, terephthalic acid, chlorendic acid, tetrabromophthalic acid and the like, and their corresponding anhydrides where such anhydrides exist. Long chain dimer acids may be used to form useful polyols by esterification with polyols, especially diols such as ethylene glycol and the like. For the purposes of this invention, the polyesters should have a minimum hydroxyl number of about 200 and preferably above about 250, with best results being obtained from those polyesters having hydroxyl numbers in excess of about 300.

Another useful class of polyols which can be employed are the trialkanolamines which, by reaction with alkylene oxides, form adducts of suitable molecular weight, and the alkylene oxide adducts thereof. Illustrative of the lower molecular weight trialkanolamines include triethanolamine, triisopropanolamine and tributanolamine. The alkylene oxide adducts which can be employed are preferably those wherein the oxyalkylene moieties thereof have from 2 to 4 carbon atoms.

Another useful class of polyols which can be employed are the alkylene oxide adducts of mono- and polyamines and also ammonia. These may be termed aminic polyols. The mono- and polyamines are preferably reacted with alkylene oxides which have 2 to 4 carbon atoms, for example, ethylene oxide, 1,2-epoxypropane, the epoxybutanes, and mixtures thereof. Mono- and polyamines suitable for reaction with alkylene oxides include, among others, methylamine, ethylamine, isopropylamine, butylamine, benzylamine, aniline, the toluidines, naphthylamines, ethylenediamine, diethylenetriamine, triethylenetetraamine, 1,3-butanediamine, 1,3-propanediamine, 1,4-butanediamine, 1,2-, 1,3-, 1,4-, 1,5- and 1,6-hexanediamine, phenylenediamines, toluenediamine, naphthalenediamines and the like. Among the compounds of the above groups which are of particular interest are, among others, N,N,N′,N′-tetrakis(2-hydroxyethyl)ethylenediamine; N,N,N′,N′ tetrakis(2-hydroxypropyl)ethylenediamine; N,N,N′,N′-pentakis (2-hydroxypropyl)diethylenetriamine; phenyldiisopropanolanine and higher alkylene oxide adducts of aniline, and the like. Others which deserve particular mention are the alkylene oxide adducts of aniline or substituted aniline/formaldehyde condensation products.

Most foam formulations described herein will require a catalyst, preferably an amine compound such as triethylene diamine, bis(2-dimethylaminoethyl)ether and metallic soaps such as dibutyltin dilaurate or stannous octoate. A few of the foam formulations described herein require no catalyst. Such formulations will contain rather substantial quantities of such amino hydrogen donors such as triethanolamine or other such highly reactive nitrogen containing compounds.

The foam that serves as the scaffold for the oil absorbing polyurethane will be of the general class known as open-cell foams. A preferred embodiment is the sub-class known as reticulated polyurethane foams. These foams and the methods for producing them are well known in the art. Reticulated foams are typically produced by the so-called “one-shot” process wherein all of the ingredients are mixed in a single step to produce the final foam product. Using heat and pressure in specially designed vessels, a flexible skeletal foam structure without cell membranes is produced.

The open-pore scaffold can be produced within a range of precisely controlled pore sizes that contain void volumes of up to 98% and surface areas of up to 2000 ft²/ft³. Depending on the pore size, the scaffold may have 4 to 100 pores per linear inch (ppi). This enables the hydrophobic polyurethane to be tailored for specific applications. The high porosity of this material also helps control permeability and adds to design flexibility.

Among the benefits of reticulated hydrophobic polyurethane foams are ease of fabrication and chemical resistance. Such reticulated foams also exhibit high tensile strength, elongation and tear properties that allow such fabrication techniques as cutting, shaping, stapling, tacking, stitching, cementing, laminating and grommeting. The reticulated hydrophobic polyurethane is supplied in sheets, rolls, die-cuts, and complex compound shapes.

Hydrophobic polyurethane foams which have been found suitable for use in the foam composite of the present invention include without limitation those marketed under the trademarks Crest Foam and FoamEx. These products are commercially available from Crest Foam, Moonachie, N.J., USA and Foamex, Eddystone, Pa., USA.

The hydrophobic polyurethane coating comprises from 0.5% to 50% by weight of the open cell hydrophobic polyurethane scaffold. Desirably it comprises from 1% to 40% by weight and preferably comprises from 20% to 25% by weight.

The resulting foam composite of the present invention has a density from about 0.03 g/cc to about 0.10 g/cc. Its pore size distribution varies from about 8 pores per linear inch ppi) to about 100 ppi. In a preferred embodiment the pore size distribution is from about 10 ppi to about 45 ppi, where the ratio of the weight of the open cell hydrophobic polyurethane coating to the weight of the hydrophobic foam scaffold is from about 0.01 to about 15, and preferably from about 0.5 to about 10 depending upon the application for which the foam composite has been engineered. The surface area of the foam composite of the invention varies from about 100 ft²/ft³ to about 2000 ft²/ft³ and preferably from about 300 ft²/ft³ to about 2000 ft²/ft³.

### EXAMPLE 1

An alcohol reacted prepolymer was made by reacting dodecanol with an isocyanate prepolymer supplied by Chemron Corporation, Paso Robles, Calif., according to U.S. Pat. No. 4,230,566. It was mixed with a polyol also supplied by Chemron Corporation in a ratio of 20 parts prepolymer to 1 part polyol. Immediately after mixing it was poured onto a piece of 35 ppi reticulated form (FoamEx S-35, Eddystone, Pa.). The prepolymer/polyol mixture and the foam were mechanically kneaded so as to fully coat the surfaces of the pores of the hydrophobic reticulated foam and thus created a uniform coating of the reticulate. The sample became tack-free in 30 minutes at ambient temperature.

### EXAMPLE 2

The sample produced in Example 1 was cut into pieces and subjected to a number of experiments.

A drop of SAE 30 motor oil was placed in the surface of a water bath. It immediately soaked into the treated reticulated foam. The same procedure was repeated except a piece of untreated reticulated foam was used. The oil failed to soaked into the untreated foam.

A pan was filled half way with seawater. SAE 30 weight oil was added until it completely covered the surface. The thickness of the oil layer was about 1 mm. A piece of treated reticulated foam prepared in Example 1 and a piece of untreated reticulated foam were placed on the surface simultaneously. Visual inspection revealed that the oil soaked into the foam produced in Example 1 immediately while the untreated foam did not absorb the oil.

### EXAMPLE 3

A weighed sample of the material prepared in Example 1 was placed in a bottle of water and 30-weight motor oil. The bottle was capped and shaken mechanically for 30 minutes. The samples were carefully removed and weighed. They were then dried at 75° C. for 1 hour and reweighed. The same test was conducted on samples of a commercially available non-woven reported to be used as an oil absorbant pad. From these data, the amounts of water and oil absorbed by the respective products were calculated. The following table reports the results:

| | Oil | Water | O/W Weight Ratio |
|---|---|---|---|
| Treated | 57 | 22 | 2.6 |
| Polyurethane | | | |
| 3M | 31 | 34 | 0.9 |
| Commercial | | | |
| product | | | |
| Untreated | 15 | 11 | 1.4 |
| Reticulate | | | |

### EXAMPLE 4

A dispersion of motor oil was produced using a dishwasher soap. The dispersion was passed through a column containing the composite prepared in Example 1. Analysis of the effluent from the column revealed that 85% by weight of the oil had been removed.

While the invention has been described as preferably using a reticulated foam a non-woven material could also be coated with the alcohol modified hydrophobic polyurethanes.

What is claimed is:

1. A foam composite adapted to remove sparingly soluble hydrocarbon contaminants from water comprising: a scaffold of an open cell hydrophobic polyurethane foam, said foam having a plurality of pores having a plurality of surfaces, the surfaces of said pores having a coating of hydrophobic polyurethane disposed thereupon.

2. A composite as recited in claim 1 wherein the hydrophobic polyurethane prepolymer comprises a C₈-C₁₂ monohydric alcohol reacted with a polyisocyanate.

3. A composite as recited in claim 2 wherein the amount of alcohol is 10-25% of the stoichiometric amount required for complete reaction with said polyisocyanate.

4. A process of making a foam composite adapted to remove sparingly soluble hydrocarbons from a waste stream which comprises:
(a) preparing a hydrophobic polyurethane prepolymer comprising the reaction product of a C8-C12 monohydric alcohol with a polyisocyanate,
(b) contacting an open cell hydrophobic polyurethane foam having a plurality of pores having a plurality of surfaces with said hydropobic polyurethane prepolymer and a plyol and
(c) curing said prepolymer while in contact with said hydrophobic polyurethane for a period of time sufficient to form a coating of hydrophobic polyurethane on the surfaces of the pores of said hydrophobic polyurethane foam.

5. A process for removing sparingly soluble hydrocarbon contaminants from water comprising: contacting the contaminated water with a foam composite comprising a scaffold of an open cell hydrophobic polyurethane foam, said foam having a plurality of pores having a plurality of surfaces, the surfaces of said pores having a coating of hydrophobic polyurethane disposed thereupon.
